(19) United States
(12) Patent Application Publication
(10) Pub. No.: US 2011/0267245 A1
(43) Pub. Date: Nov. 3, 2011

(54) MULTIPLE-INPUT MULTIPLE-OUTPUT ANTENNA SYSTEM

(75) Inventors: Gyu Bok PARK, Yongin-si (KR); Se Hyun PARK, Suwon-si (KR); Dong Hyun LEE, Suwon-si (KR); Austin KIM, Seongnam-si (KR); Joon Ho BYUN, Yongin-si (KR); Jae Hoon JO, Seoul (KR); Kyung Kyun KANG, Suwon-si (KR)

(73) Assignee: SAMSUNG ELECTRONICS CO. LTD., Suwon-si (KR)

(21) Appl. No.: 13/051,382

(22) Filed: Mar. 18, 2011

(30) Foreign Application Priority Data
May 3, 2010 (KR) 10-2010-0041244

(51) Int. Cl. H01Q 5/01

(52) U.S. Cl. 343/722

(57) ABSTRACT

A Multiple-Input Multiple-Output (MIMO) antenna system with multiple antennas is provided. The MIMO antenna system includes a number of conductive elements, and a number of band stop devices. The conductive elements are spaced apart from each other and operate in corresponding resonant frequency bands respectively when they receive electric power. When the conductive elements are operated, the band stop devices block interference between the conductive elements in the resonant frequency bands, and isolate the conductive elements from each other. The band stop devices are located between adjacently separate conductive elements and connect the conductive elements to each other. The MIMO antenna system can stop interference between the conductive elements via the band stop devices, thereby increasing the operational efficiency of the conductive elements.

### PRIORITY

This application claims the benefit under 35 U.S.C. §119(a) of a Korean patent application filed on May 3, 2010 in the Korean Intellectual Property Office and assigned Serial No. 10-2010-0041244, the entire disclosure of which is hereby incorporated by reference.

### BACKGROUND OF THE INVENTION

1. Field of the Invention

This present invention relates to antennas. More particularly, the present invention relates to a Multiple-Input Multiple-Output (MIMO) antenna system with multiple antennas.

2. Description of the Related Art

In recent years, wireless communication systems have provided multi-media services such as video playback, audio playback, games, etc. Such wireless communication systems should guarantee a high speed data transfer rate for such a large amount of multi-media data, thereby providing smooth multi-media services. To this end, the conventional wireless communication systems have employed a Multiple-Input Multiple-Output (MIMO) antenna system that includes multiple antennas. The MIMO antenna system can allow for high speed data transfer as antennas configured at a transmitter and a receiver can transmit and receive different signals in a frequency band therebetween.

FIG. 1 illustrates a graph that describes the resonance characteristic of a conventional Multiple-Input Multiple-Output (MIMO) antenna system.

Referring to FIG. 1, the conventional MIMO antenna system is disadvantageous in that electromagnetic coupling occurs between the antennas and causes interference. For example, as shown in FIG. 1, when the antennas are resonating simultaneously and respectively, interference occurs in a first resonant frequency band 81 and second resonant frequency band 83. This interference becomes more serious due to the minimization of the MIMO antenna system for the implementation of small mobile devices. As the interval between the antennas decreases in order to minimize the MIMO antenna system, interference between the antennas increases.

### SUMMARY OF THE INVENTION

An aspect of the present invention is to address at least the above-mentioned problems and/or disadvantages and to provide at least the advantages described below. Accordingly, an aspect of the present invention is to provide a Multiple-Input Multiple-Output (MIMO) antenna system that can block interference between the antennas.

In accordance with an aspect of the present invention, a MIMO antenna system is provided. The system includes a plurality of conductive elements spaced apart from each other for operating in a number of resonant frequency bands individually and respectively when they receive electric power, and a plurality of band stop devices for blocking interference between the conductive elements in the resonant frequency bands when the conductive elements are operated and for isolating the conductive elements from each other, wherein the band stop devices are located between adjacently separate conductive elements and connect the conductive elements.

According to another aspect of the present invention, a MIMO antenna system is provided. The MIMO antenna system includes a board body shaped as a flat plate, two conductive elements for operating in two resonant frequency bands individually and respectively when they receive electric power, the two conductive elements arranged adjacent to the edge of one side of the board body and spaced apart from each other, a ground plate, mounted to the other side of the board body, for grounding the two conductive elements, and two band stop devices for blocking interferences between the two conductive elements in the resonant frequency bands when the two conductive elements are operated and for isolating the two conductive elements from each other, wherein the two band stop devices are spaced apart each other in a separate direction from the ground plate and connect the two conductive elements.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a graph that describes the resonance characteristic of a conventional Multiple-Input Multiple-Output (MIMO) antenna system;

FIG. 2 illustrates a perspective view of a MIMO antenna system according to an exemplary embodiment of the present invention, seen from one side;

FIG. 3 illustrates a perspective view of the MIMO antenna system shown in FIG. 2 according to an exemplary embodiment of the present invention, seen from another side;

FIG. 4 illustrates an equivalent circuit of the MIMO antenna system shown in FIG. 2 according to an exemplary embodiment of the present invention;

FIG. 5 illustrates a graph that describes the resonant characteristic of the MIMO antenna system shown in FIG. 2 according to an exemplary embodiment of the present invention;

FIGS. 6A to 6C illustrate views that describe current distribution of the MIMO antenna system shown in FIG. 2 according to an exemplary embodiment of the present invention;

FIG. 7 illustrates a perspective view of a MIMO antenna system according to an exemplary embodiment of the present invention, seen from one side;

FIG. 8 illustrates a perspective view of the MIMO antenna system shown in FIG. 7 according to an exemplary embodiment of the present invention, seen from another side;

FIG. 9 illustrates an equivalent circuit of the MIMO antenna system shown in FIG. 7 according to an exemplary embodiment of the present invention;

FIG. 10 illustrates a graph that describes the resonant characteristic of the MIMO antenna system shown in FIG. 7 according to an exemplary embodiment of the present invention;

FIGS. 11A and 11B illustrate views that describe current distribution of the MIMO antenna system shown in FIG. 7 according to an exemplary embodiment of the present invention;

FIG. 12 illustrates a perspective view of a MIMO antenna system according to an exemplary embodiment of the present invention, seen from one side; and

FIG. 13 illustrates a perspective view of the MIMO antenna system shown in FIG. 12 according to an exemplary embodiment of the present invention, seen from another side.

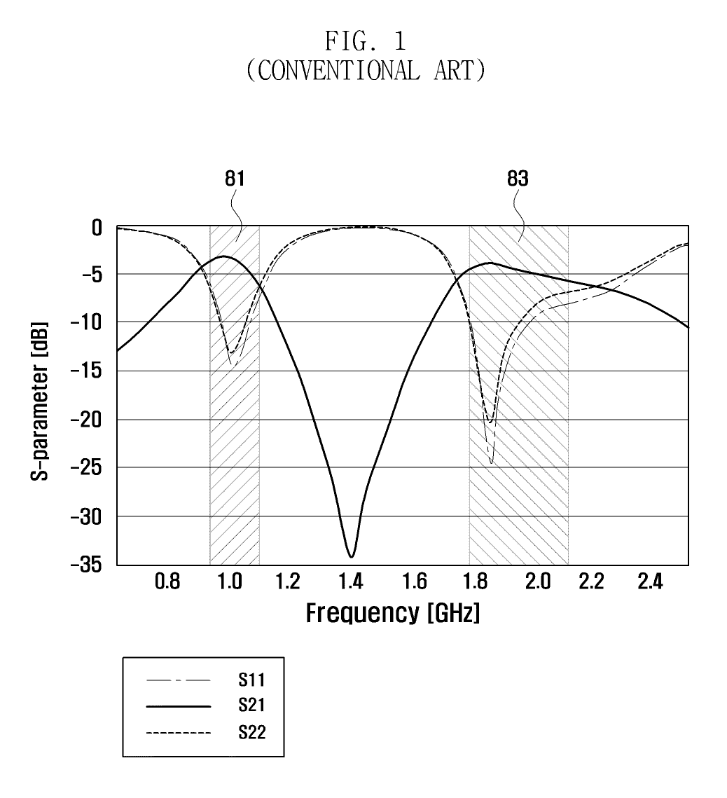

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

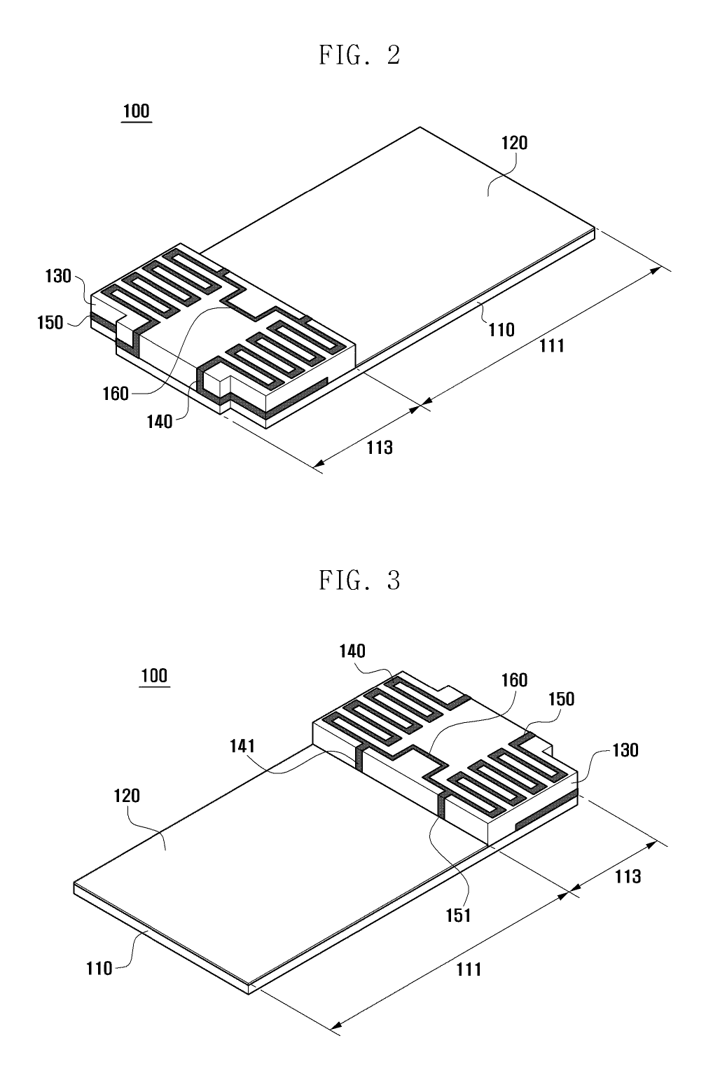

FIGS. 2 and 3 illustrate perspective views of a first embodiment of a MIMO antenna system 100 according to an exemplary embodiment of the present invention, seen from one side and another, respectively. The MIMO antenna system 100 may be implemented with a Printed Circuit Board (PCB).

Referring to FIGS. 2 and 3, the MIMO antenna system 100 includes a board body 110, a ground plate 120, a device carrier 130, conductive elements 140 and 150, and a band stop device 160.

The board body 110 supports and supplies electric power to the MIMO antenna system 100. The board body 110 is shaped as a flat plate with at least four edges. The board body 110 may be divided into a ground region 111 and a device region 113. The board body 110 includes a dielectric substance containing a number of electric wires (not shown). The board body 110 may also be implemented in such a manner that a number of dielectric plates are stacked. Both ends of the respective electric wires are exposed to the outside. One side end of the electric wires is connected to an external electric power source (not shown), and the other side end of the electric wires is exposed via the device region 113. The electric wires receive electric power from the external electric power source via their one side ends, and supply the electric power to the elements in the MIMO antenna system 100 via the other side ends. In an embodiment of the invention, a portion of the electric wires are blocked to supply electric power.

The ground plate 120 grounds the MIMO antenna system 100 to a ground. The ground plate 120 is placed on the ground region 111 of the board body 110. The ground plate 120 is shaped as a flat configuration. The ground plate 120 may be placed parallel to the one-side surface of the board body 110, so that it can cover the whole area of the ground region 111. Alternatively, the ground plate 120 may be placed vertically against the one-side surface of the board body 110, in an area of the ground region 111. In addition, the ground plate 120 may be implemented as a flat plate with various types of grooves or holes.

The device carrier 130 serves as media in the MIMO antenna system 100. The device carrier 130 is mounted to the device region 113 of the board body 110. The device carrier 130 is shaped as a flat plate of a thickness so that the board body 110 is spaced apart such that the board body 110 can form a space. The device carrier 130 exposes the other ends of the electric wires in the device region 113. The device carrier 130 is shaped to correspond to the form of the device region 113, or to protrude from the device region 113. The device carrier 130 is made of a dielectric substance, the property of which may be identical to or different from that of the board body 110. The device carrier 130 may be made of a dielectric substance with a relatively high loss.

The conductive elements 140 and 150 perform signal transmission and reception in the MIMO antenna system 100. The conductive elements 140 and 150 transmit and receive electromagnetic waves in a number of resonant frequency bands via resonance. The conductive elements 140 and 150 are placed in the device region 113 and are spaced apart from each other. The conductive elements 140 and 150 are made of a metal material and configure a transfer circuit.

The conductive elements 140 and 150 are patterned on the surface of the device carrier 130, thereby being placed in the device region 113. The conductive elements 140 and 150 are placed above the board body 110 and the ground plate 120 by the thickness of the device carrier 130. The conductive elements 140 and 150 may be shaped symmetrically or asymmetrically to each other. Each of the conductive elements 140 and 150 is shaped to have at least one bent portion. Alternatively, the conductive elements 140 and 150 may also be formed as at least one of a meander type, a spiral type, a step type, and a loop type.

The conductive elements 140 and 150 are connected to the other ends of the electric wires respectively. These connected points form electric power supply points 141 and 151 at side ends of the conductive elements 140 and 150. The conductive elements 140 and 150 are also grounded via the ground plate 120. To this end, the conductive elements 140 and 150 can be connected to the ground plate 120, via the other ends. When electric power is supplied to the electric power supply points 141 and 151, the conductive elements 140 and 150 are resonated in the resonant frequency bands. When the supply of electric power is blocked to part of the conductive elements 140 and 150, a part of the conductive elements 140 and 150 can be resonated in the resonant frequency bands. The operation of one of the conductive elements 140 and 150 creates magnetic fields that interfere with the other of the conductive elements 140 and 150.

The band stop device 160 blocks interference between the conductive elements 140 and 150 in the MIMO antenna system 100. To this end, the band stop device 160 stops interference between the conductive elements 140 and 150 in one of the resonant frequency bands. The band stop device 160 stops one of the signals in resonant frequency bands and passes the remaining signals. The band stop device 160 is placed between the conductive elements 140 and 150 in the device region 113 of the board body 110, and connects the conductive elements 140 and 150 to each other. The band stop device 160 is made of a metal material and configures a transfer circuit.

The band stop device 160 is patterned on the surface of the device carrier 130, thereby being placed in the device region 113. The band stop device 160 is placed above the board body 110 and the ground plate 120 by the thickness of the device carrier 130. The band stop device 160 is shaped to have at least one bent portion. Alternatively, the band stop device 160 may also be formed as at least one of a meander type, a spiral type, a step type, and a loop type.

Each end of the band stop device 160 is connected to one of the respective conductive elements 140 and 150 respectively. When electric power is supplied to the conductive elements 140 and 150, the band stop device 160 establishes an electric power supply path. The band stop device 160 is grounded via the ground plate 120. When electric power is supplied to the system, the band stop device 160 can stop interference between the conductive elements 140 and 150 in one of the resonant frequency bands. Therefore, the band stop device 160 can isolate the conductive elements 140 and 150 from each other.

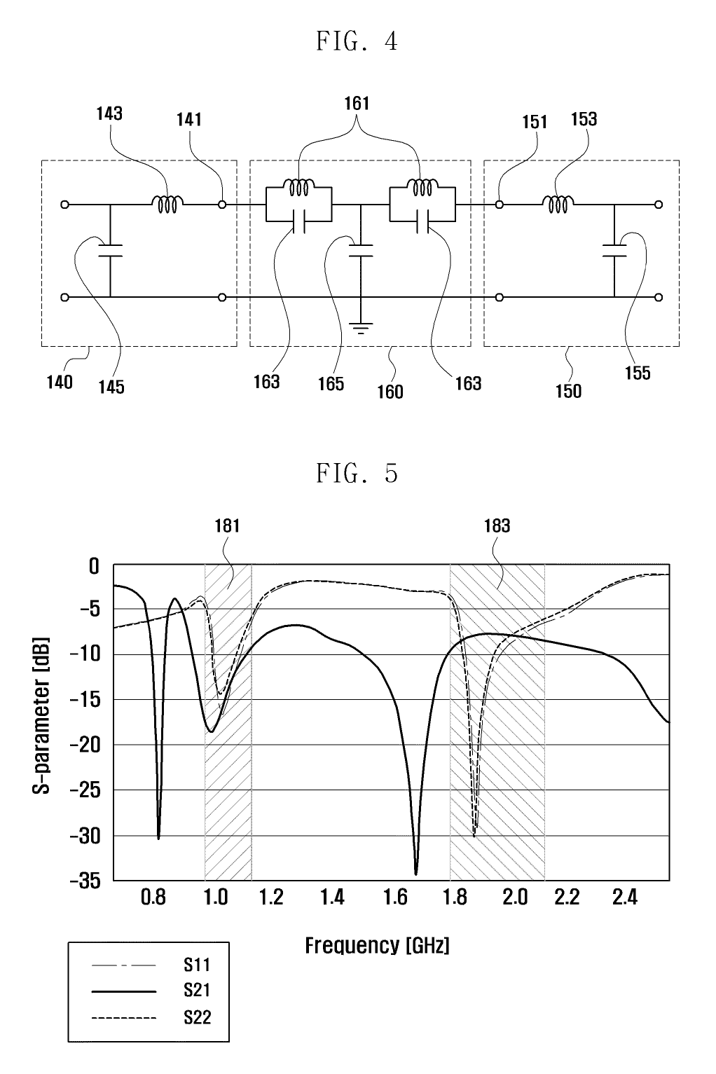

In order to perform the functions described above, the MIMO antenna system 100 is designed in such a manner that the conductive elements 140 and 150 and the band stop device 160 have different inductances and capacitances respectively. This is described in detail below with respect to FIG. 4.

FIG. 4 illustrates an equivalent circuit of the MIMO antenna system shown in FIG. 2 according to an exemplary embodiment of the present invention. The conductive elements 140 and 150 and the band stop device 160 are described below as if they are each configured as a single cell. However, it should be understood that the invention is not limited to this exemplary embodiment. For example, the conductive elements 140 and 150 and the band stop device 160 may each be configured as various types of cells or a combination thereof.

Referring to FIG. 4, the conductive elements 140 and 150 are connected to each other via the band stop device 160. The conductive elements 140 and 150 are configured to have conductance and capacitance in order to resonate in the resonant frequency bands respectively. The conductive elements 140 and 150 include device inductors 143 and 153 and device capacitors 145 and 155 respectively. The respective conductive elements 140 and 150 are configured in such a manner that the device inductor 143 and the device capacitor 145 are connected in parallel and the device inductor 153 and the device capacitor 155 are also in parallel. The other ends of the device inductors 143 and 153 are connected to the electric power supply terminals 141 and 151 respectively.

As described above, the conductive elements 140 and 150 can be configured as the equivalent circuits, and their electric characteristics can be shown according to the configuration of the transfer circuit. The transfer circuit can be divided into horizontal and vertical component circuits. The horizontal component circuit includes the circuit components (horizontal circuit components) arranged in the horizontal direction on the ground plate 120. The vertical component circuit includes the circuit components (vertical circuit components) arranged in the vertical direction with respect to the ground plate 120.

The characteristics of the device inductors 143 and 153 are determined according to the respective areas of the conductive elements 140 and 150, or by the entire lengths and widths of the horizontal and vertical component circuits, respectively. Likewise, the characteristics of the device capacitors 145 and 155 are determined according to the lengths of the vertical component circuits and the interval between the horizontal component circuits of the conductive elements 140 and 150 and the ground plate 120, respectively. From this configuration, the MIMO antenna system 100 may have a reduced size, even with the conductive elements 140 and 150.

The band stop device 160 is configured to have inductance and capacitance in order to stop interference between the conductive elements 140 and 150 in one of the resonant frequency bands. The inductance and capacitance of the band stop device 160 are determined in consideration of the conditions when it is coupled with the device inductors 143 and 153 of the conductive elements 140 and 150. The band stop device 160 includes band stop inductors 161 and band stop serial capacitors 163, which are coupled to each other in parallel, and a band stop parallel capacitor 165. One side end of the band stop inductors 161 and the band stop serial capacitors 163 are connected via the electric power supply terminals 141 and 151 to the conductive elements 140 and 150, respectively. The band stop inductors 161 and the band stop serial capacitors 163 are serially connected to the device inductors 143 and 153 of the conductive elements 140 and 150, respectively. In addition, the band stop parallel capacitor 165 is connected in parallel to the band stop inductors 161 and band stop serial capacitors 163 and the conductive elements 140 and 150.

As described above, the band stop device 160 can be configured as the equivalent circuit, and its electric characteristic can be shown according to the configuration of the transfer circuit. The transfer circuit can be divided into horizontal and vertical component circuits with respect to the ground plate 120. The horizontal component circuit includes the circuit components (horizontal circuit components) arranged in the horizontal direction on the ground plate 120. The vertical component circuit includes the circuit components (vertical circuit components) arranged in the vertical direction with respect to the ground plate 120.

The characteristics of the band stop inductors 161 of the band stop device 160 are determined according to the area of the band stop device 160, or by the entire lengths and widths of the horizontal and vertical component circuits respectively. In addition, the characteristics of the band stop serial capacitors 163 are determined according to the interval between the vertical component circuits of the band stop device 160. Likewise, the characteristic of the band stop parallel capacitor 165 is determined according to the lengths of the vertical component circuits and the interval between the horizontal component circuits of the band stop device 160 and the ground plate 120, respectively. From this configuration, the MIMO antenna system 100 may have a reduced size even with the band stop device 160.

As a result, the MIMO antenna system 100 has an enhanced operation characteristic. This is described in detail below with respect to FIGS. 5 and 6.

FIG. 5 illustrates a graph that describes the resonant characteristic of the MIMO antenna system shown in FIG. 2 according to an exemplary embodiment of the present invention. The graph, as the radio frequency characteristic curve, shows the change in the S-parameter versus frequency. S-parameter refers to an index that indicates the ratio of input voltage to output voltage (output voltage/input voltage) according the frequency bands, and is described with dB scale. S11 and S22 denote the change in S-parameters according to the conductive elements 140 and 150, respectively. S21 denotes the change in S-parameter according to interference between the conductive elements 140 and 150.

Referring to FIG. 5, the MIMO antenna system 100 can resonate in a number of resonant frequency bands, such as a first resonant frequency band 181 and a second resonant frequency band 183. For example, the first resonant frequency band 181 corresponds to approximately 93˜1120 MHz, and the second resonant frequency band 183 approximately 178˜2110 MHz. The conductive elements 140 and 150 of the MIMO antenna system 100 can have a return loss of −5 dB in the first and second resonant frequency bands 181 and 183. While operating, the MIMO antenna system 100 can stop interference between the conductive elements 140 and 150 in one of the first and second resonant frequency bands 181 and 183. The band stop device 160 can stop interference between the conductive elements 140 and 150 in the first resonant frequency band 181 for example.

FIGS. 6A to 6C illustrate views that describe current distribution of the MIMO antenna system shown in FIG. 2 according to an exemplary embodiment of the present invention. In the following description, it is assumed that the MIMO antenna system 100 is operated in the first resonant frequency band 181.

Referring to FIGS. 6A to 6C, when the conductive elements 140 and 150 are operated in the first resonant frequency band 181, the band stop device 160 blocks the current flow between the conductive elements 140 and 150. The band stop device 160 can stop interference between the conductive elements 140 and 150 in the first resonant frequency band 181. This interference blocking can be also achieved when electric power is supplied to part of the conductive elements 140 and 150 as shown in FIGS. 6A and 6B, or to all the conductive elements 140 and 150 as shown in FIG. 6C.

As described above, when the MIMO antenna system 100 operates, the conductive elements 140 and 150 resonate in the first and second resonant frequency bands 181 and 183, and the band stop device 160 stops interference between the conductive elements 140 and 150 in the first resonant frequency band 181. The band stop device 160 blocks interference between the conductive elements 140 and 150. This means that the band stop device 160 isolates the conductive elements 140 and 150 from each other. Accordingly, the MIMO antenna system 100 can increase the operational efficiency of the conductive elements 140 and 150.

Although the exemplary embodiment described above is implemented in such a manner that the MIMO antenna system includes one band stop device to stop interference between the conductive elements in one of a number of resonant frequency bands, it should be understood that the invention is not limited to this embodiment. For example, the MIMO antenna system may be configured to include a number of band stop devices, so that it can stop the interference between the conductive elements in all the resonant frequency bands.

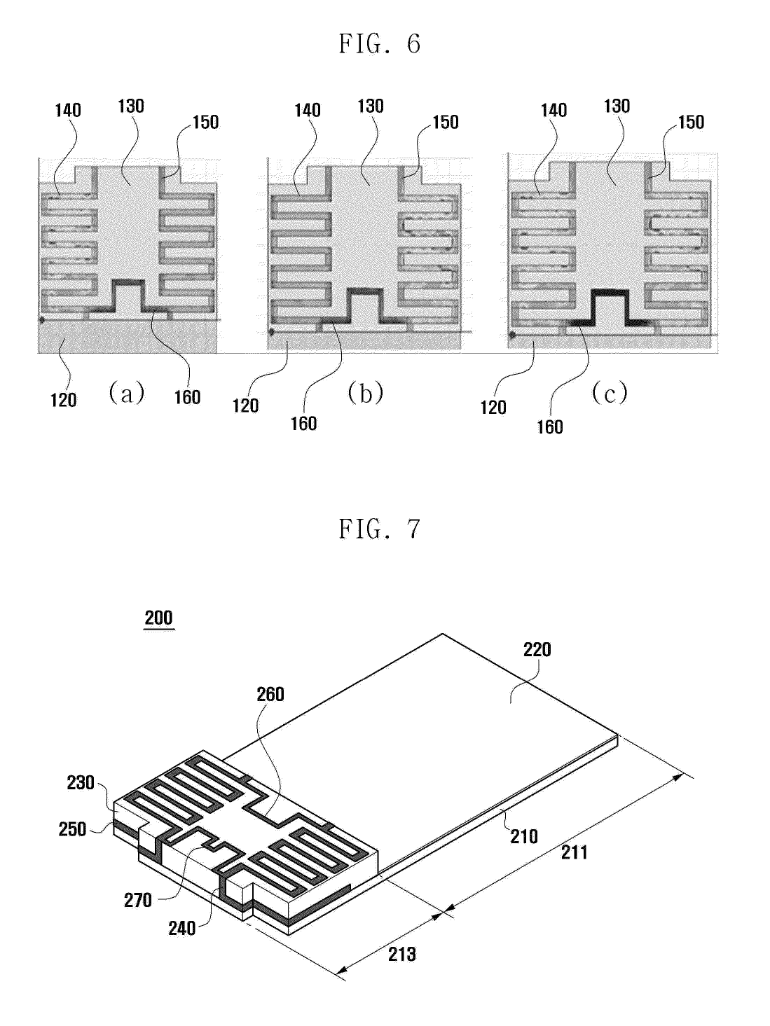

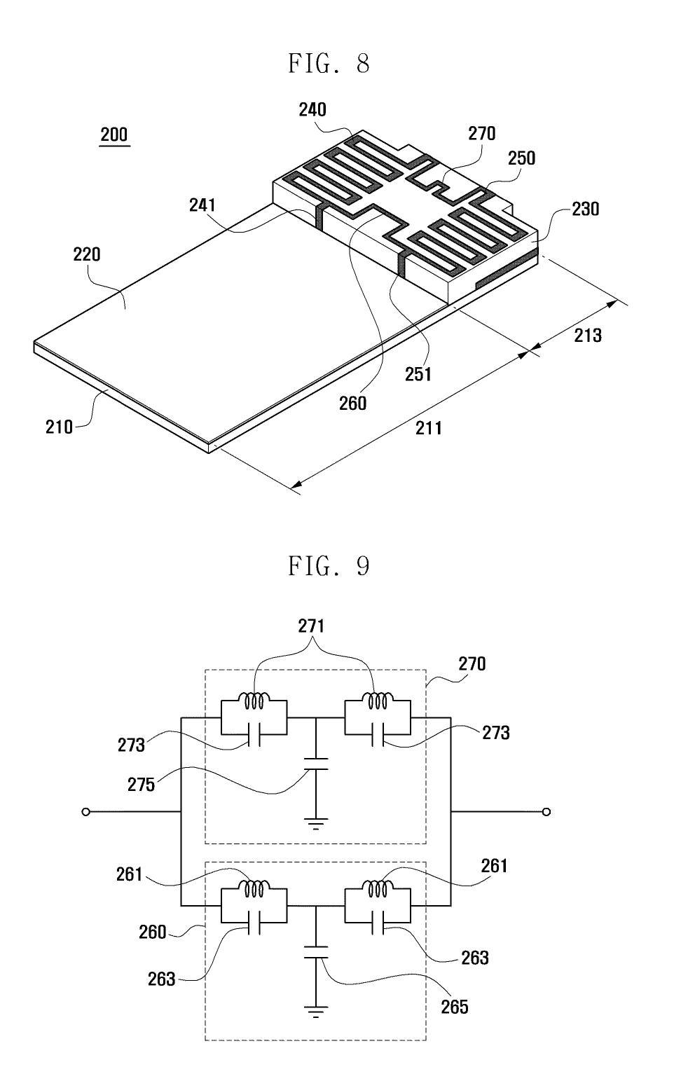

FIG. 7 illustrates a perspective view of a MIMO antenna system according to an exemplary embodiment of the present invention, seen from one side. FIG. 8 illustrates a perspective view of the MIMO antenna system shown in FIG. 7 according to an exemplary embodiment of the present invention, seen from another side. The MIMO antenna system 200 may be implemented with a PCB.

Referring to FIGS. 7 and 8, the MIMO antenna system 200 includes a board body 210 divided into a ground region 211 and a device region 213, a ground plate 220, a device carrier 230, conductive elements 240 and 250, and band stop devices 260 and 270. Since the board body 210, the ground plate 220, the device carrier 230, and conductive elements 240 and 250 are similar to corresponding components included in the exemplary embodiment shown in FIGS. 2 to 6, their detailed descriptions are omitted in the following description.

The band stop devices 260 and 270 block interference between the conductive elements 240 and 250 in the MIMO antenna system 200. To this end, the band stop devices 260 and 270 stop interference between the conductive elements 240 and 250 in the resonant frequency bands. The band stop devices 260 and 270 stop the signals in resonant frequency bands and pass the remaining signals. The band stop devices 260 and 270 are placed between the conductive elements 240 and 250 in the device region 213 of the board body 210, and connect the conductive elements 240 and 250 to each other. The band stop devices 260 and 270 are spaced apart from each other in a separate direction from the ground plate 220. The band stop devices 260 and 270 are made of a metal material and configure a transfer circuit.

The band stop devices 260 and 270 are patterned on the surface of the device carrier 230, thereby being placed in the device region 213. The band stop devices 260 and 270 are placed above the board body 210 and the ground plate 220 by the thickness of the device carrier 230. The band stop devices 260 and 270 are each shaped to have at least one bent portion. Alternatively, each of the band stop devices 260 and 270 may be formed as at least one of a meander type, a spiral type, a step type, and a loop type.

The ends of the band stop devices 260 and 270 are connected to the conductive elements 240 and 250 respectively. When electric power is supplied to the conductive elements 240 and 250, electric power may also be provided to the band stop devices 260 and 270. The band stop devices 260 and 270 are grounded via the ground plate 220. When electric power is supplied to the system, the band stop devices 260 and 270 can stop interference between the conductive elements 240 and 250 in the resonant frequency bands. Therefore, the band stop devices 260 and 270 can isolate the conductive elements 240 and 250 from each other.

In order to perform the functions described above, the MIMO antenna system 200 is designed in such a manner that the conductive elements 240 and 250 and the band stop devices 260 and 270 have different inductances and capacitances respectively. This is described in detail below with respect to FIG. 9.

FIG. 9 illustrates an equivalent circuit of the MIMO antenna system shown in FIG. 7 according to an exemplary embodiment of the present invention.

Referring to FIG. 9, the conductive elements 240 and 250 are connected to each other via the respective band stop devices 260 and 270. The conductive elements 240 and 250 and the band stop devices 260 and 270 are described as if they are each configured as a single cell. However, it should be understood that the invention is not limited to this exemplary embodiment. For example, the conductive elements 240 and 250 and the band stop devices 260 and 270 may be configured as various types of cells or a combination thereof.

The band stop devices 260 and 270 are configured to have inductance and capacitance in order to stop interference between the conductive elements 240 and 250 in the resonant frequency bands. The inductance and capacitance of the band stop devices 260 and 270 are determined in consideration of the conditions when they are coupled with the device inductors 243 and 253 of the conductive elements 240 and 250. The band stop devices 260 and 270 include band stop inductors 261 and 271 and band stop serial capacitors 263 and 273 respectively, which are coupled to each other in parallel, and band stop parallel capacitors 265 and 275 respectively. One side end of the band stop inductors 261 and 271 and the band stop serial capacitors 263 and 273 are connected via the electric power supply terminals 241 and 251 to the respective conductive elements 240 and 250. The band stop inductors 261 and 271 and the band stop serial capacitors 263 and 273 are serially connected to the device inductors 243 and 253 of the conductive elements 240 and 250, respectively. In addition, the band stop parallel capacitors 165 and 275 are each connected in parallel to the band stop inductors 261 and 271 and band stop serial capacitors 263 and 273, and the conductive elements 240 and 250.

As described above, the band stop devices 260 and 270 can be configured as the equivalent circuit, and their electric characteristic can be shown according to the configuration of the transfer circuit. The transfer circuit can be divided into horizontal and vertical component circuits with respect to the ground plate 220. The horizontal component circuit includes the circuit components (horizontal circuit components) arranged in the horizontal direction on the ground plate 220. The vertical component circuit includes the circuit components (vertical circuit components) arranged in the vertical direction with respect to the ground plate 220.

The characteristics of the band stop inductors 261 and 271 of the band stop devices 260 and 270 are determined according to the area of the band stop devices 260 and 270, or by the entire lengths and widths of the horizontal and vertical component circuits respectively. In addition, the characteristics of the band stop serial capacitors 263 and 273 are determined according to the interval between the vertical component circuits of each of the band stop devices 260 and 270. Likewise, the characteristic of the band stop parallel capacitors 265 and 275 is determined, according to the lengths of the vertical component circuits and the interval between the horizontal component circuits of each of the band stop devices 260 and 270 and the ground plate 220, respectively. From this configuration, the size of the MIMO antenna system 200 is reduced, even with the band stop devices 260 and 270.

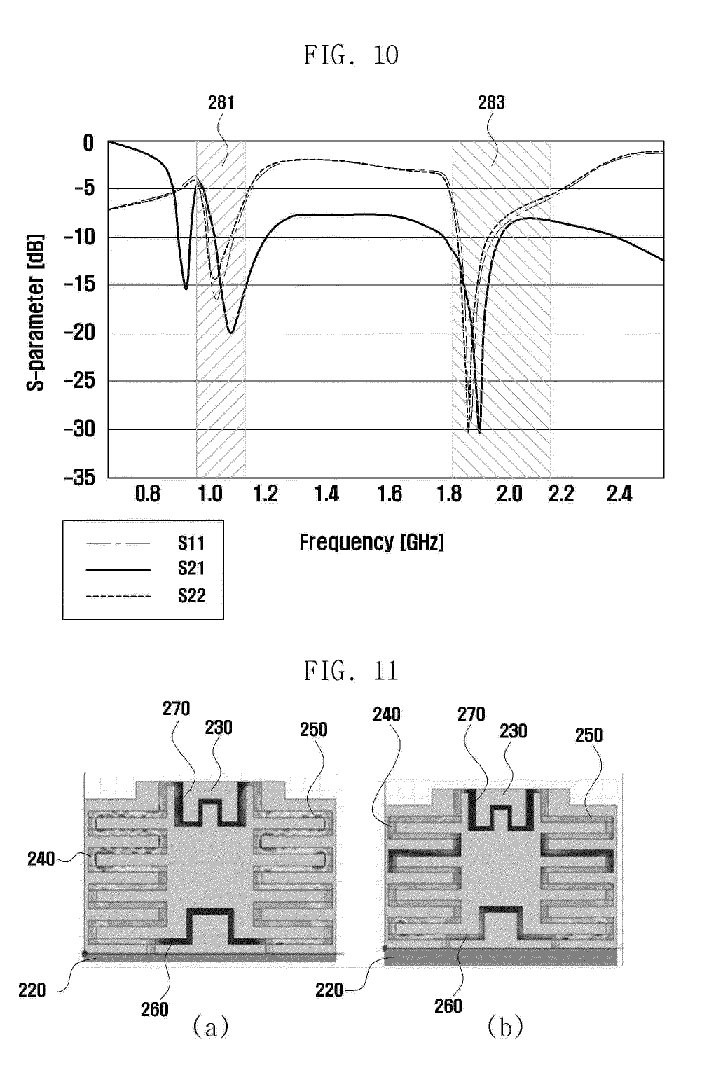

Accordingly, the MIMO antenna system 200 has an enhanced operation characteristic. This is described in detail below referring to FIGS. 10 and 11.

FIG. 10 illustrates a graph that describes the resonant characteristic of the MIMO antenna system shown in FIG. 7 according to an exemplary embodiment of the present invention. The graph, as the radio frequency characteristic curve, shows the change in the S-parameter versus frequency. S-parameter refers to an index that indicates the ratio of input voltage to output voltage (output voltage/input voltage) according the frequency bands, and is described with dB scale. S11 and S22 denote the change in S-parameters according to the conductive elements 240 and 250, respectively. S21 denotes the change in S-parameter according to interference between the conductive elements 240 and 250.

Referring to FIG. 10, the MIMO antenna system 200 can resonate in a number of resonant frequency bands, such as a first resonant frequency band 281 and a second resonant frequency band 283. For example, the first resonant frequency band 281 may correspond to approximately 93˜1120 MHz, and the second resonant frequency band 283 may correspond to approximately 178˜2110 MHz. The conductive elements 240 and 250 of the MIMO antenna system 200 can have a return loss of −5 dB in the first and second resonant frequency bands 281 and 283. While operating, the MIMO antenna system 200 can stop interference between the conductive elements 240 and 250 in the first and second resonant frequency bands 281 and 283. In particular, one of the band stop devices 260 and 270, closer to the ground plate 220, can stop interference between the conductive elements 240 and 250 in the first resonant frequency band 281 for example. In addition, mutual cooperation of the band stop devices 260 and 270 can stop interference between the conductive elements 240 and 250 in the second resonant frequency band 283.

FIGS. 11A and 11B illustrate views that describe current distribution of the MIMO antenna system shown in FIG. 7 according to an exemplary embodiment of the present invention. In the following description, it is assumed that the MIMO antenna system 200 is operated in the first 181 or second 183 resonant frequency band according to an exemplary embodiment of the present invention.

Referring to FIGS. 11A and 11B, when the conductive elements 240 and 250 operate in the first 281 or second 283 resonant frequency band, the band stop devices 260 and 270 blocks the current flow between the conductive elements 240 and 250. The band stop devices 260 and 270 can stop interference between the conductive elements 240 and 250 in the first 281 and second 283 resonant frequency bands. This interference blocking may also be achieved when the conductive elements 240 and 250 are supplied with electric power and operate in the first resonant frequency band 281 as shown in FIG. 11A and in the second resonant frequency band 283 as shown in FIG. 11B.

As described above, when the MIMO antenna system 200 operates, the conductive elements 240 and 250 resonate in the first and second resonant frequency bands 281 and 283, and the band stop devices 260 and 270 stop interference between the conductive elements 240 and 250 in the first and second resonant frequency bands 281 and 283. The band stop devices 260 and 270 block interference between the conductive elements 240 and 250. This means that the band stop devices 260 and 270 isolate the conductive elements 240 and 250 from each other. Accordingly, the MIMO antenna system 200 can increase the operational efficiency of the conductive elements 240 and 250.

Although the second embodiment is implemented in such a manner that the MIMO antenna system includes a number of band stop devices to stop interference between the conductive elements in a number of resonant frequency bands, it should be understood that the invention is not limited to this embodiment. For example, the MIMO antenna system may be implemented in such a manner that one band stop device is adjusted in its location.

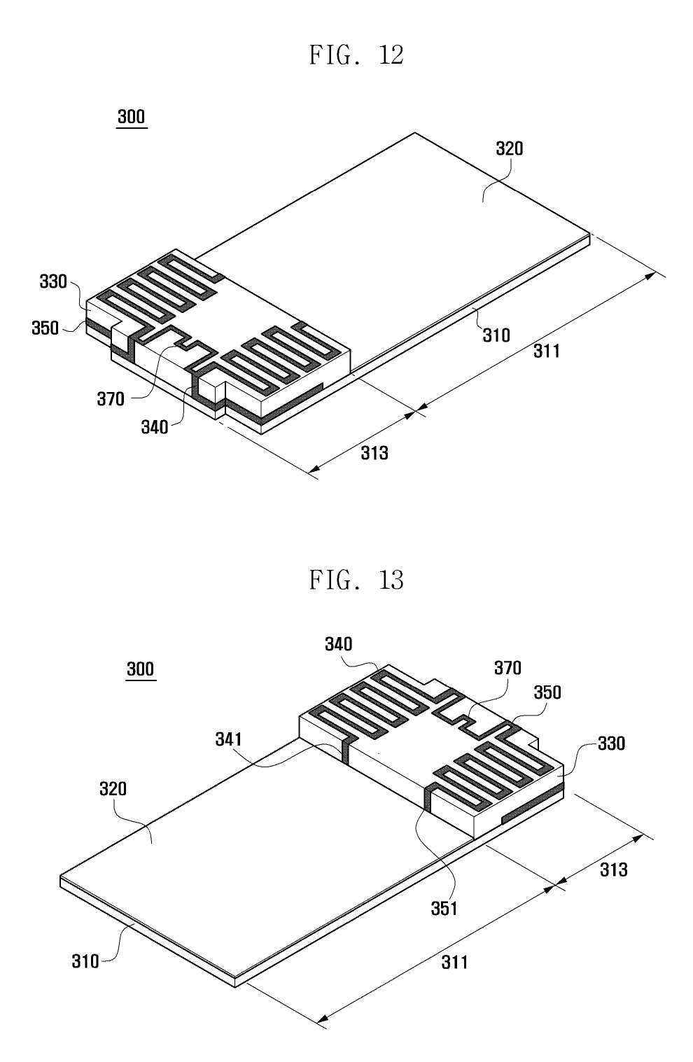

FIG. 12 illustrates a perspective view of a MIMO antenna system according to an exemplary embodiment of the present invention, seen from one side. FIG. 13 illustrates a perspective view of the MIMO antenna system shown in FIG. 12 according to an exemplary embodiment of the present invention, seen from another side. The MIMO antenna system 300 may be implemented with a Printed Circuit Board (PCB).

Referring to FIGS. 12 and 13, the MIMO antenna system 300 includes a board body 310 divided into a ground region 311 and a device region 313, a ground plate 320, a device carrier 330, conductive elements 340 and 350, and a band stop device 370. Since the board body 310, the ground plate 320, the device carrier 330, and conductive elements 340 and 350 are similar to corresponding components included in the exemplary embodiment shown in FIGS. 2 to 6, their detailed descriptions are omitted in the following description.

Unlike the exemplary embodiment shown in FIGS. 2 and 3, the band stop device 370 connects the electric power supply points 341 and 351 via its relatively long length. Accordingly, when electric power is supplied to the conductive elements 340 and 350, the band stop device 370 establishes a relatively long electric power supply path between the electric power supply points 341 and 351. When electric power is supplied to the system, the band stop device 370 can stop interference between the conductive elements 340 and 350 in one of the resonant frequency bands. Therefore, the band stop device 370 can isolate the conductive elements 340 and 350 from each other.

Although the exemplary embodiments according to the MIMO antenna system are each implemented in such a manner that the board body forms two conductive elements and one or two band stop devices are placed between the two conductive elements, it should be understood that the invention is not limited to these exemplary embodiments. For example, the MIMO antenna system may also be configured in such a manner that the board body forms three or more conductive elements. In addition, the MIMO antenna system may also be implemented so that three or more band stop devices are placed between the conductive elements. For example, at least one band stop device may be placed between two conductive elements. In that case, the MIMO antenna system allows the conductive elements to resonate in two or more resonant frequency bands, so that the band stop devices can stop interference between the conductive elements.

In addition, the MIMO antenna system may also be configured in such a manner that the conductive elements and the band stop devices are not patterned on the device carrier. For example, the MIMO antenna system can be implemented in such a way that the conductive elements and the band stop devices are directly patterned on the board body. In that case, the MIMO antenna system does not require the device carrier. Alternatively, the MIMO antenna system can also be implemented in such a manner that a portion of the conductive elements and band stop devices are patterned on the device carrier and the remaining portions are patterned on the board body. In that case, the MIMO antenna system includes at least one or more device carriers that are placed separately arranged on the board body.

The MIMO antenna system may also be implemented in such a manner that the conductive elements and/or the band stop device are formed as a device coupling configuration to have inductance, capacitance, etc. For example, the conductive elements are configured as transfer circuits, and the band stop device is also formed as a device coupling configuration. Alternatively, the conductive elements are configured as device coupling configurations, and the band stop device is also formed as a transfer circuit. Alternatively, the conductive elements and the band stop device are all formed as device coupling configurations.

The MIMO antenna system may also be configured in such a manner that each of the conductive elements is implemented with a transfer circuit of metamaterials. Metamaterials refer to artificially synthetic materials that have electromagnetic structure so that they can display a particular electromagnetic property that cannot easily be seen in the physical world. Metamaterials have negative permittivity and negative permeability under the specific conditions, and display an electromagnetic wave transmission characteristic that differs from general materials or their electromagnetic structure. Exemplary embodiments of the present invention may employ the metamaterials with a Composite Right/Left Handed (CRLH) structure in order to use an inverted phase speed of electromagnetic waves. The CRLH structure comprises Right Handed (RH) and Left Handed (LH) structures. The RH structure shows a general characteristic that the direction of propagation of the electric fields, magnetic fields, electromagnetic wave complies with the right hand rule. Likewise, the LH structure displays a general characteristic that the direction of propagation of the electric fields, magnetic fields, electromagnetic wave complies with the left hand rule.

As described above, the MIMO antenna system can block the interference between the conductive elements that are being resonated. When the conductive elements resonate, the MIMO antenna system allows the band stop device to block interference between the conductive elements in the resonant frequency bands, and isolates the conductive elements from each other, thereby stopping the interference. The MIMO antenna system can increase the operation efficiency in the conductive elements.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A Multiple-Input Multiple-Output (MIMO) antenna system, the system comprising:
a plurality of conductive elements spaced apart from each other for operating in a number of resonant frequency bands individually and respectively when they receive electric power; and
a plurality of band stop devices for blocking interference between the conductive elements in the resonant frequency bands when the conductive elements are operated and for isolating the conductive elements from each other, wherein the band stop devices are located between adjacently separate conductive elements and connect the conductive elements.

2. The system of claim 1, further comprising:
a board body, including the conductive elements and the band stop devices thereon, for supporting the conductive elements and the band stop devices; and
a ground plate, placed on the board body, for grounding the conductive elements and the band stop devices to the ground.

3. The system of claim 2, wherein the band stop devices are located between adjacently separated conductive elements, and are separated in a separate direction from the ground plate.

4. The system of claim 3, wherein each of the band stop devices is a transfer circuit with a number of bent portions, and is formed as at least one of a meander type, a spiral type, a step type, and a loop type.

5. The system of claim 4, wherein each of the conductive elements is a transfer circuit with a number of bent portions, and is formed as at least one of a meander type, a spiral type, a step type, and a loop type.

6. The system of claim 5, wherein the conductive elements or the band stop devices are patterned on the board body.

7. The system of claim 5, further comprising:
a device carrier that is mounted to the board body and forms patterns via the conductive elements and the band stop devices.

8. The system of claim 1, wherein each of the band stop devices comprises:
band stop inductors;
band stop serial capacitors; and
a band stop parallel capacitor,
wherein the band stop inductors and the band stop serial capacitors are coupled to each other in parallel, and are serially connected to the conductive elements, and the band stop parallel capacitor is connected in parallel to the band stop inductors and band stop serial capacitors and the conductive elements.

9. A Multiple-Input Multiple-Output (MIMO) antenna system, the system comprising:
a board body shaped as a flat plate;
two conductive elements for operating in two resonant frequency bands individually and respectively when they receive electric power, the two conductive elements arranged adjacent to the edge of one side of the board body and spaced apart from each other;
a ground plate, mounted to the other side of the board body, for grounding the two conductive elements; and
two band stop devices for blocking interferences between the two conductive elements in the resonant frequency bands when the two conductive elements are operated and for isolating the two conductive elements from each other, wherein the two band stop devices are spaced apart each other in a separate direction from the ground plate and connect the two conductive elements.

10. The system of claim 9, wherein:
one of the band stop devices is closer to the ground plate than the other and block interference in one of the two resonant frequency bands; and
the other band stop device blocks interference in the other of the two resonant frequency bands.

11. The system of claim 9, wherein each of the band stop devices is a transfer circuit with a number of bent portions, and is formed as at least one of a meander type, a spiral type, a step type, and a loop type.

12. The system of claim 9, further comprising:
a device carrier mounted to the board body and forming patterns via the conductive elements and the band stop devices.
